(19) United States
(12) Patent Application Publication
(10) Pub. No.: US 2024/0351145 A1
(43) Pub. Date: Oct. 24, 2024

(54) LASER PROCESSING DEVICE AND LASER PROCESSING METHOD

(71) Applicant: KOMATSU INDUSTRIES CORPORATION, Kanazawa-shi, Ishikawa (JP)

(72) Inventors: Yoshihiro YAMAGUCHI, Kanazawa-shi, Ishikawa (JP); Nobuhiro TAKATA, Kanazawa-shi, Ishikawa (JP); Shigeru NOZAKI, Kanazawa-shi, Ishikawa (JP)

(73) Assignee: KOMATSU INDUSTRIES CORPORATION, Kanazawa-shi, Ishikawa (JP)

(21) Appl. No.: 18/685,381

(22) PCT Filed: Aug. 3, 2022
(86) PCT No.: PCT/JP2022/029836

§ 371 Date: Feb. 21, 2024

(30) Foreign Application Priority Data
Sep. 22, 2021 (JP) 2021-154161

(51) Int. Cl. B23K 26/70

(52) U.S. Cl. CPC B23K 26/702

(57) ABSTRACT

A laser head emits a laser beam. A liquid tank includes containers separated from each other so as to be capable of individually storing a transmission inhibition liquid. Each of the containers is capable of supporting workpieces to be processed by the laser head. Each of the containers individually includes a liquid level adjustment mechanism, and the liquid level of the transmission inhibition liquid in each of the containers is independently adjusted.

### TECHNICAL FIELD

The present disclosure relates to a laser processing device and a laser processing method.

### BACKGROUND ART

For example, Japanese Patent Laying-Open No. 8-132270 (PTL 1) and Japanese Patent Laying-Open No. 62-168692 (PTL 2) disclose a device in which water in the laser processing device is used.

In PTL 1, the laser processing is performed while a lower portion of the workpiece is immersed in cooling water in a water tank of a processing table. Thus, the entire workpiece can be cooled from below, and stable processing can be performed.

In PTL 2, the workpiece supported by a frog pin is subjected to the laser processing while water is poured in a mounting box of the frog pin. The water in the water tank cools the workpiece during laser cutting to prevent scattering of dust.

### CITATION LIST

### Patent Literature

PTL 1: Japanese Patent Laying-Open No. 8-132270

PTL 2: Japanese Patent Laying-Open No. 62-168692

### SUMMARY OF INVENTION

### Technical Problem

A series of processing processes in the laser processing device is performed in order of carrying the workpiece in the laser processing device, processing by the laser processing device, and carrying out the workpiece from the laser processing device. For this reason, processing work is interrupted when the workpiece is carried in or carried out from the laser processing device. Accordingly, work efficiency in the laser processing in which the liquid is used is degraded.

An object of the present disclosure is to provide a laser processing device and a laser processing method having the good work efficiency in the laser processing in which the liquid is used.

### Solution to Problem

A laser processing device of the present disclosure includes a laser head, a liquid tank, a first liquid level adjustment mechanism, and a second liquid level adjustment mechanism. The laser head emits the laser beam. The liquid tank includes a first container and a second container separated from each other so as to be capable of individually storing a liquid, and is capable of supporting a workpiece to be processed by the laser head in each of the first container and the second container. The first liquid level adjustment mechanism adjusts a liquid level of the liquid stored in the first container. The second liquid level adjustment mechanism operates independently of the first liquid level adjustment mechanism and adjusts the liquid level of the liquid stored in the second container.

A laser processing method of the present disclosure is a laser processing method for processing a workpiece using a laser beam, and includes the following steps.

Liquid is stored in each of a first container and a second container separated from each other. A liquid level of liquid in the first container and a liquid level of liquid in the second container are adjusted independently of each other while the workpiece is supported by each of the first container and the second container.

### Advantageous Effects of Invention

According to the present disclosure, it is possible to realize the laser processing device and the laser processing method having the good work efficiency in the laser processing in which the liquid is used.

### BRIEF DESCRIPTION OF DRAWINGS

FIG. 1 is a perspective view illustrating a configuration of a laser processing device according to an embodiment.

FIG. 2 is a sectional perspective view illustrating an internal configuration of a container used in the laser processing device of FIG. 1.

FIG. 3 is a sectional view illustrating a configuration of a processing head used in the laser processing device of FIG. 1.

FIG. 4 is a sectional view illustrating a configuration of a laser beam shielding member used in the laser processing device of FIG. 1.

FIG. 5 is a sectional view illustrating a configuration of a liquid level adjustment mechanism used in the laser processing device of FIG. 1.

FIG. 6 is a perspective view illustrating a configuration of a partition wall detachable from the container.

FIG. 7 is a functional block diagram illustrating a controller in FIG. 5.

FIG. 8 is a sectional view illustrating a state of processing the workpiece while the partition wall is removal.

### DESCRIPTION OF EMBODIMENT

With reference to the drawings, an embodiment of the present disclosure will be described in detail below. In the specification and the drawings, the same components or corresponding components are denoted by the same reference numerals, and redundant description will not be repeated. In the drawings, the construction may be omitted or simplified for convenience of description.

A planar view in the following description means a viewpoint viewed from a direction orthogonal to a plane on which a plurality of placement units 2c are located. A planar shape means a shape in the planar view.

### Construction of Laser Processing Device

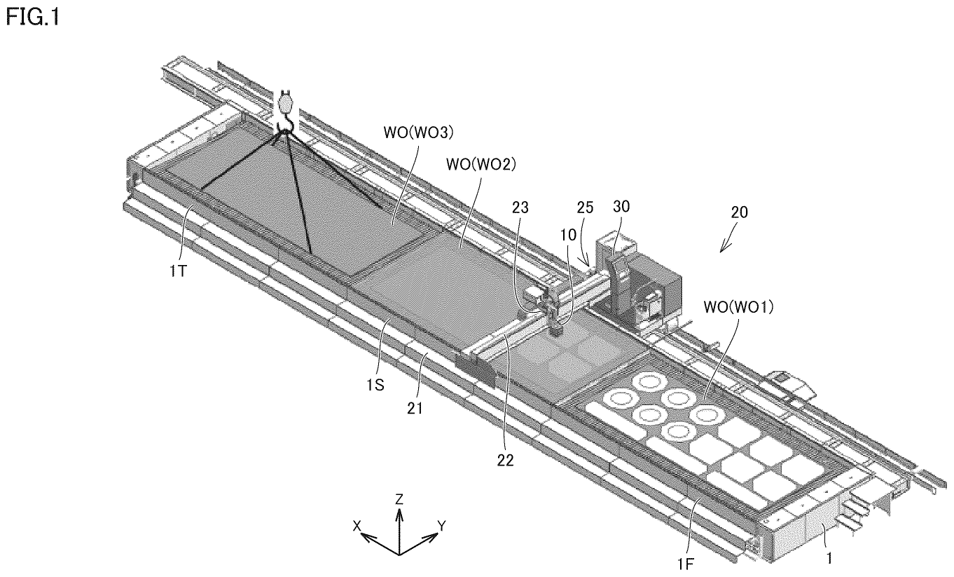

With reference to FIGS. 1 to 6, a configuration of a laser processing device according to an embodiment will be described below.

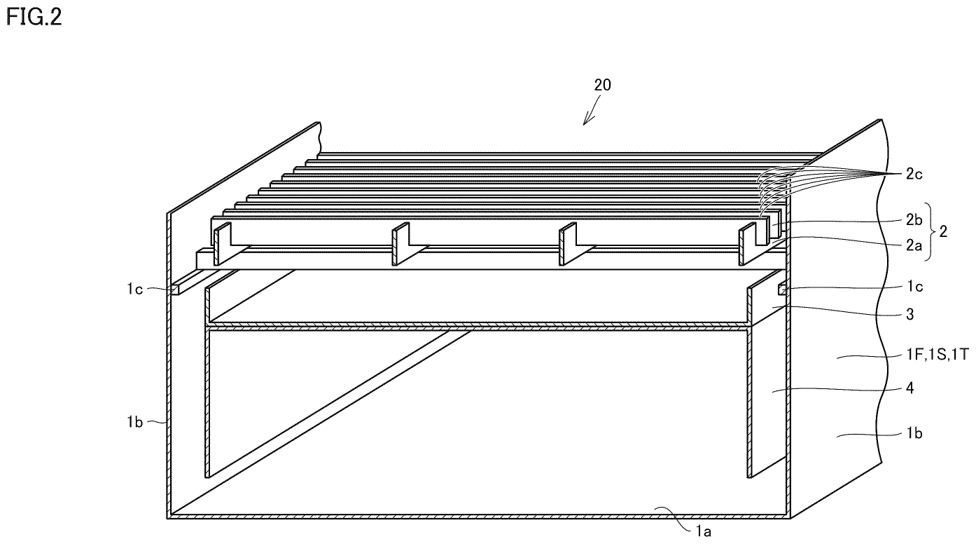

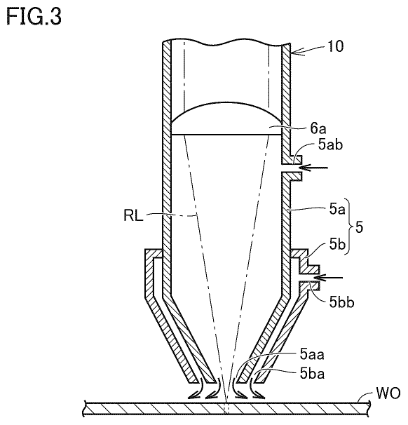

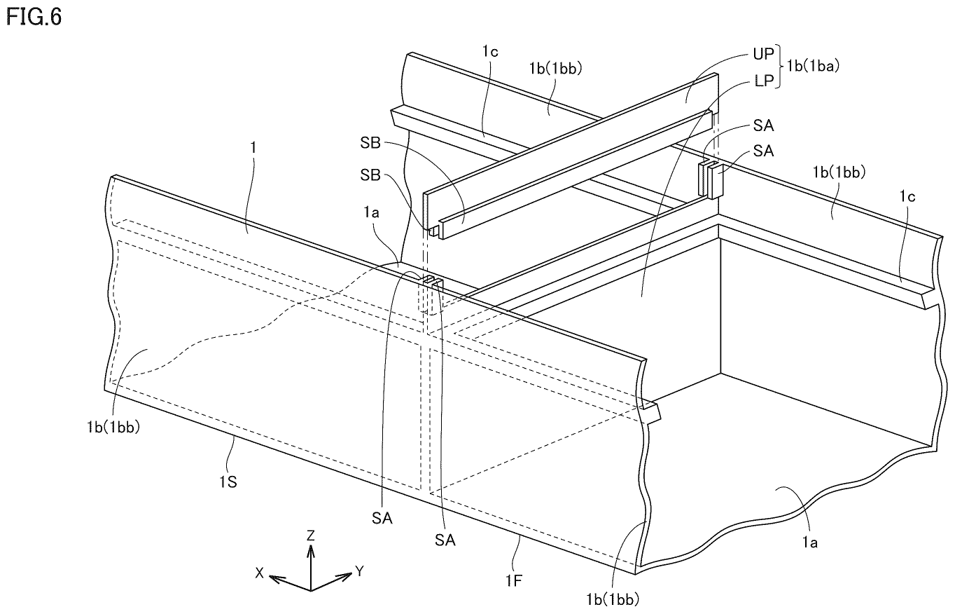

FIG. 1 is a perspective view illustrating the construction of the laser processing device of the embodiment. FIG. 2 is a sectional perspective view illustrating an internal configuration of a container used in the laser processing device of FIG. 1. FIGS. 3, 4, and 5 are sectional views illustrating configurations of a processing head, a laser beam shielding member, and a liquid level adjustment mechanism used in the laser processing device of FIG. 1. FIG. 6 is a perspective view illustrating a configuration of a partition wall detachable from a container.

As illustrated in FIG. 1, a laser processing device 20 of the embodiment processes a workpiece WO (WO1 to WO3) using a laser beam. For example, workpiece WO (WO1 to WO3) is made of a steel material.

Laser processing device 20 includes a liquid tank 1. For example, liquid tank 1 has a rectangular planar shape. For example, liquid tank 1 includes three containers 1F, 1S, 1T. A number of containers included in liquid tank 1 is not limited to three, but may be two or at least four, and may be a plurality of containers.

Each of containers 1F, 1S, 1T has a rectangular shape having a side in a longitudinal direction (X-direction) and a side in a short direction (Y-direction) in planar view. The planar shape of each of containers 1F, 1S, 1T is not limited to the rectangular shape, but may be a square shape. For example, three containers 1F, 1S, 1T are arranged in the X-direction in order of container 1F, container 1S, and container 1T.

The sides of containers 1F, 1S, 1T in the longitudinal direction (X-direction) are arranged along one straight line in planar view. The side in the short direction (Y-direction) is positioned between container 1F and container 1S and between container 1S and container 1T.

Each of containers 1F, 1S, 1T can support workpieces WO1, WO2, WO3.

Laser processing device 20 includes a drive mechanism 25. Drive mechanism 25 moves laser head 10 in the X-direction (longitudinal direction of liquid tank 1), the Y-direction (short direction of liquid tank 1), and the Z-direction (vertical direction). Drive mechanism 25 mainly includes a pair of left and right support bases 21, an X-direction movable base 22, a Y-direction movable base 23, and laser head 10.

A pair of left and right support bases 21 is disposed so as to sandwich liquid tank 1 in the Y-direction. Each of the pair of left and right support bases 21 extends in the X-direction. X-direction movable base 22 is disposed across the pair of left and right support bases 21 by extending in the Y-direction. X-direction movable base 22 is driven in the X-direction along the support base 21 by an X-axis motor (not illustrated).

Y-direction movable base 23 is supported to be movable in the Y-direction with respect to X-direction movable base 22 by, for example, a rack and pinion mechanism. Y-direction movable base 23 is driven in the Y-direction by a Y-axis motor (not illustrated).

Laser head 10 is supported to be movable in the Z-direction with respect to Y-direction movable base 23 by, for example, a rack and pinion mechanism. Laser head 10 is driven in the Z-direction by a Z-axis motor (not illustrated).

Drive mechanism 25 allows laser head 10 to move on each of the plurality of containers 1F, 1S, 1T. Thus, laser head 10 can process workpiece WO (WO1 to WO3) supported by each of the plurality of containers 1F, 1S, 1T. Laser processing device 20 may include a plurality of Y-direction movable bases 23, and each of Y-direction movable bases 23 may include laser head 10. Furthermore, laser processing device 20 may include a plurality of laser heads 10 on one Y-direction movable base 23. That is, laser processing device 20 may include the plurality of laser heads 10.

An operation panel 30 receives input of a processing condition such as a plate thickness, a material, and a processing speed of workpiece WO (WO1 to WO3). Operation panel 30 includes a display, a switch, and an alarm. The display displays an input screen of the machining condition, a screen indicating an operating status of laser processing device 20, and the like.

As illustrated in FIG. 2, the internal configurations of the plurality of containers 1F, 1S, 1T are the same as each other. A cutting pallet 2, a sludge tray 3, and a liquid level adjustment tank 4 are disposed in each of the plurality of containers 1F, 1S, 1T.

Each of the plurality of containers 1F, 1S, 1T includes a rectangular bottom wall 1a and four side walls 1b rising from four sides of bottom wall 1a. Each of the plurality of containers 1F, 1S, 1T has a bottomed cylindrical shape opening upward. Each of the plurality of containers 1F, 1S, 1T has an opening at an upper end and an internal space extending from the opening to an inside of each of the plurality of containers 1F, 1S, 1T.

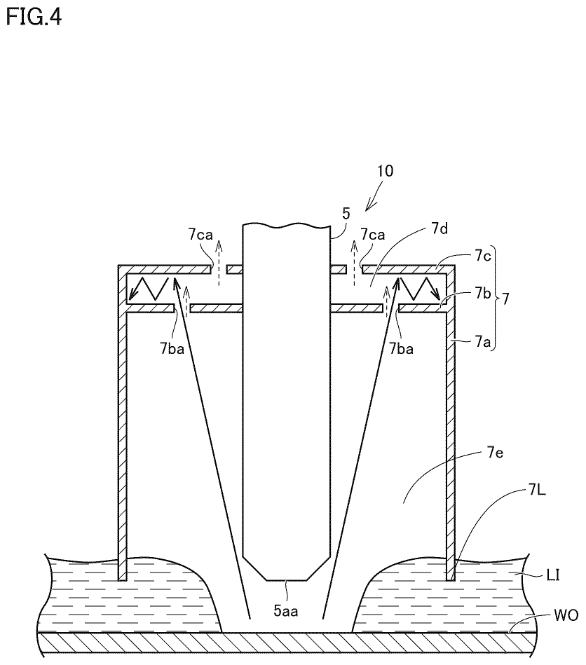

Each of the plurality of containers 1F, 1S, 1T is configured to be able to store a liquid (transmission inhibition liquid LI in FIG. 4) therein. A pallet support 1c is provided in side wall 1b. Pallet support 1c protrudes laterally from a wall surface of side wall 1b toward the internal space of each of the plurality of containers 1F, 1S, 1T.

Liquid level adjustment tank 4 is independently disposed in the internal space of each of the plurality of containers 1F, 1S, 1T. That is, liquid level adjustment tank 4 disposed in the internal space of container 1F, liquid level adjustment tank 4 disposed in the internal space of container 1S, and liquid level adjustment tank 4 disposed in the internal space of container IT are independent by being separated from each other. Liquid level adjustment tank 4 disposed in each of containers 1F, 1S, 1T has a box shape having the opening at a lower end. Through this opening, the internal space of liquid level adjustment tank 4 is connected to the internal space of each of the plurality of containers 1F, 1S, 1T.

Liquid level adjustment tank 4 is constructed to be able to store gas in the internal space of liquid level adjustment tank 4. The gas can be supplied to or discharged from the internal space of liquid level adjustment tank 4. Transmission inhibition liquid LI in liquid level adjustment tank 4 can be pushed out of liquid level adjustment tank 4 by supplying the gas into the internal space of liquid level adjustment tank 4. Transmission inhibition liquid LI can be taken in from the outside to the inside of liquid level adjustment tank 4 by discharging the gas from the internal space of liquid level adjustment tank 4. Thus, the liquid level in each of the plurality of containers 1F, 1S, 1T can be individually adjusted.

As described above, liquid level adjustment tank 4 is individually disposed in each of the plurality of containers 1F, 1S, 1T, so that the liquid level of transmission inhibition liquid LI can be adjusted independently in each of the plurality of containers 1F, 1S, 1T.

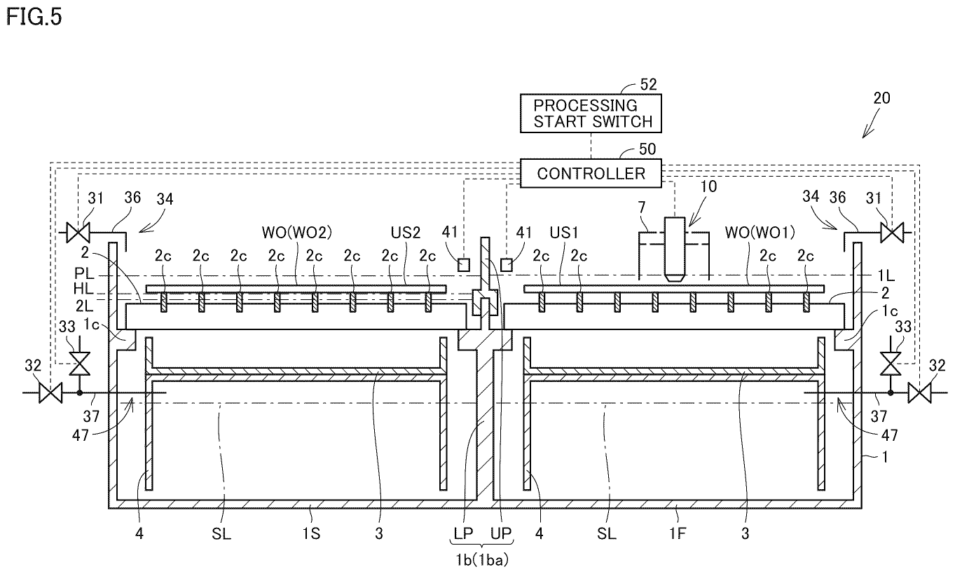

Sludge tray 3 is disposed above liquid level adjustment tank 4. Sludge tray 3 has a box shape including the opening at the upper end. Sludge tray 3 can accumulate sludge generated when a workpiece WO (FIG. 5) is cut by laser processing. The sludge generated during the laser processing falls from workpiece WO and is accumulated inside sludge tray 3 through an opening at an upper end of sludge tray 3.

Cutting pallet 2 is supported by each of containers 1F, 1S, 1T using pallet support 1c. Cutting pallet 2 is disposed in the internal space of each of containers 1F, 1S, 1T and above sludge tray 3. Cutting pallet 2 includes a plurality of first support plates 2a and a plurality of second support plates 2b. The plurality of first support plates 2a and the plurality of second support plates 2b are assembled in a lattice shape by being arranged vertically and horizontally.

Cutting pallet 2 includes a placement unit 2c that supports a lower surface of workpiece WO (FIG. 5). For example, placement unit 2c of cutting pallet 2 is constructed by an upper end of each of the plurality of second support plates 2b.

Placement unit 2c is located at a position lower than the upper end of liquid tank 1 (the upper end of side wall 1b). The upper end of each of containers 1F, 1S, 1T is located at the position higher than the upper surface of workpiece WO while workpiece WO is placed on placement unit 2c. Thus, when each of containers 1F, 1S, 1T is filled with transmission inhibition liquid LI while workpiece WO is placed on placement unit 2c, the liquid level of transmission inhibition liquid LI can be made higher than the upper surface of workpiece WO.

As illustrated in FIG. 3, laser head 10 mainly includes a head body 5 and a condensing lens 6a. Head body 5 includes a body 5a.

Body 5a has a hollow cylindrical shape. Condensing lens 6a is accommodated in body 5a. Condensing lens 6a condenses a laser beam RL on workpiece WO. Laser beam RL condensed by condensing lens 6a is emitted from a laser emission port 5aa of body 5a toward workpiece WO.

Laser beam RL used in laser processing device 20 of the embodiment has any wavelength of visible light, near-infrared light, mid-infrared light, and far-infrared light, and has a wavelength greater than or equal to 0.7 μm and less than or equal to 10 μm. For example, laser beam RL is a laser beam using fiber laser as a light source, and may be a laser beam using solid-state laser containing Yttrium Aluminum Garnet (YAG) as a light source. The fiber laser is a type of solid-state laser using an optical fiber as an amplification medium. In the fiber laser, a core located at the center of the optical fiber is doped with rare earth element Yb (ytterbium). Laser beam RL using the fiber laser as a light source is near-infrared light having a wavelength of about 1.06 μm. Running cost and maintenance cost of the fiber laser are lower than those of a carbon dioxide laser.

Body 5a includes a gas outlet 5aa and a gas supply unit 5ab. An assist gas is supplied from gas supply unit 5ab into body 5a. The assist gas supplied into body 5a is blown out from gas outlet 5aa toward workpiece WO. Gas outlet 5aa also serves as a laser emission port 5aa.

Head body 5 may further include an outer nozzle 5b. Outer nozzle 5b is attached to body 5a so as to surround the periphery of gas outlet 5aa of body 5a. A gap space is provided between the inner peripheral surface of outer nozzle 5b and the outer peripheral surface of body 5a.

Outer nozzle 5b includes a gas outlet 5ba and a gas supply unit 5bb. Each of gas outlet 5ba and gas supply unit 5bb is connected to the gap space. Gas outlet 5ba is disposed on an outer periphery of gas outlet 5aa, and has an annular shape.

The secondary gas (shielding gas) is supplied from gas supply unit 5bb to the gap space between body 5a and outer nozzle 5b. The secondary gas supplied into the gap space is blown out from gas outlet 5ba toward workpiece WO. Thus, the secondary gas is blown out from gas outlet 5ba onto the outer peripheral side of the assist gas blown out from gas outlet 5aa.

As described above, laser head 10 has gas outlets 5aa, 5ba. Gas outlets 5aa, 5ba may include gas outlet 5aa through which the assist gas is blown out and gas outlet 5ba through which the secondary gas is blown out. Gas outlet 5aa and gas outlet 5ba form a double nozzle structure.

As illustrated in FIG. 4, laser head 10 includes a light shielding cover 7. Light shielding cover 7 surrounds laser emission port 5aa (gas outlet 5aa). For example, light shielding cover 7 is made of a rubber sheet. Light shielding cover 7 includes a peripheral wall 7a, a first upper plate 7b, and a second upper plate 7c. Peripheral wall 7a has a cylindrical shape surrounding the outer periphery of head body 5.

First upper plate 7b and second upper plate 7c are attached to an upper portion of peripheral wall 7a. One or a plurality of first holes 7ba are made in first upper plate 7b. Second upper plate 7c is disposed on first upper plate 7b with a gap 7d interposed therebetween.

One or a plurality of second holes 7ca are made in second upper plate 7c. An internal space 7e of peripheral wall 7a located below first upper plate 7b is connected to the external space of light shielding cover 7 through first hole 7ba and second hole 7ca. For this reason, the gas in internal space 7e of light shielding cover 7 escapes to the outside of light shielding cover 7 through first hole 7ba and second hole 7ca as indicated by broken line arrows in FIG. 4. Accordingly, even when the liquid level of transmission inhibition liquid LI is located to the position higher than a lower end 7L of peripheral wall 7a of light shielding cover 7 during the laser processing, the gas in internal space 7e can escape to the outside of light shielding cover 7 through first hole 7ba and second hole 7ca by such the structure.

First hole 7ba, gap 7d, and second hole 7ca configure a labyrinth structure with respect to the laser beam. Specifically, as indicated by a solid arrow in FIG. 4, second hole 7ca is not positioned ahead of the laser beam that is emitted from laser emission port 5aa of laser head 10 and reflected from workpiece WO, passes through first hole 7ba, and then travels linearly in gap 7d. For example, second hole 7ca is located on the inner peripheral side of first hole 7ba at the position in a radial direction centered on head body 5.

The laser beam that passes through first hole 7ba and enters gap 7d is repeatedly reflected between first upper plate 7b and second upper plate 7c (by multiple reflection) and absorbed by light shielding cover 7. Thus, the laser beam does not leak from the inside of light shielding cover 7 to the outside.

As illustrated in FIG. 5, container 1F and container 1S are connected to each other. Although not illustrated in FIG. 5, container 1T is connected to container 1S. A connection structure between container 1T and container 1S is substantially the same as a connection structure between container 1F and container 1S.

One side wall 1ba is positioned as side wall 1b between container 1F and container 1S. Container 1F and container 1S are separated from each other by side wall 1ba. Similarly, a side wall similar to side wall 1ba is positioned between container 1S and container 1T. Container 1S and container 1T are separated from each other by the side wall positioned between container 1S and container 1T.

A liquid supply unit 34, a liquid level detection sensor 41, a liquid level adjustment mechanism 47, and a liquid discharge unit (not illustrated) are provided in each of containers 1F, 1S, 1T. By taking container F as an example, liquid supply unit 34, liquid level detection sensor 41, liquid level adjustment mechanism 47, and the liquid discharge unit that are provided in container 1F will be described below.

Liquid supply unit 34 of container 1F supplies transmission inhibition liquid LI (FIG. 4) into container 1F. Liquid supply unit 34 includes a supply pipe 36 and a supply valve 31. A supply valve 31 is attached to supply pipe 36. The supply of transmission inhibition liquid LI to the internal space of container 1F is started by opening supply valve 31, and the supply of transmission inhibition liquid LI to the internal space of container 1F is stopped by closing supply valve 31.

Liquid level detection sensor 41 of container 1F has a function of detecting the liquid level of transmission inhibition liquid LI stored in container 1F. For example, liquid level detection sensor 41 is a guide pulse type level sensor.

Liquid level adjustment mechanism 47 of container 1F adjusts the liquid level of transmission inhibition liquid LI in container 1F based on the detection result of liquid level detection sensor 41. Liquid level adjustment mechanism 47 includes liquid level adjustment tank 4, a gas pipe 37, a pressurizing valve 32, and a pressure reducing valve 33.

Gas pipe 37 is connected to liquid level adjustment tank 4 in container 1F from the outside of container 1F. A pressurizing valve 32 and a pressure reducing valve 33 are attached to gas pipe 37. The gas is supplied into liquid level adjustment tank 4 when pressurizing valve 32 is opened, and the supply of the gas into liquid level adjustment tank 4 is stopped when the pressurizing valve 32 is closed. The gas in liquid level adjustment tank 4 is discharged to the outside by opening pressure reducing valve 33, and the discharge of the gas from liquid level adjustment tank 4 is stopped by closing pressure reducing valve 33.

The liquid discharge unit (not illustrated) of container 1F includes an overflow pipe, a liquid storage tank, a liquid discharge pipe, and a discharge valve.

The overflow pipe is attached to container 1F. When the liquid level of transmission inhibition liquid LI in container 1F becomes greater than or equal to a predetermined liquid level, transmission inhibition liquid LI in container 1F is discharged to the liquid storage tank through the overflow pipe. The liquid storage tank is disposed outside liquid tank 1.

The liquid discharge pipe is attached to container 1F. The discharge valve is attached to the liquid discharge pipe. Transmission inhibition liquid LI in container 1F is discharged to the liquid storage tank by opening the discharge valve, and the discharge of transmission inhibition liquid LI from container 1F is stopped by closing the discharge valve.

Liquid supply unit 34, liquid level detection sensor 41, liquid level adjustment mechanism 47, and the liquid discharge unit provided in each of container 1S and container 1T have configurations similar to those provided in container 1F. For this reason, the same elements are denoted by the same reference numerals, and the description thereof will not be repeated.

Each of containers 1F, 1S, and 1T is configured to be capable of storing transmission inhibition liquid LI at least up to a height position HL of placement unit 2c. Each of containers 1F, 1S, 1T can store transmission inhibition liquid LI up to a position PL higher than upper surfaces US1, US2 of workpiece WO (WO1, WO2, WO3) placed on placement unit 2c. The liquid level of transmission inhibition liquid LI in each of containers 1F, 1S, 1T can be controlled independently of each other using liquid level adjustment mechanism 47 provided independently for each container.

Transmission inhibition liquid LI stored in each of containers 1F, 1S, 1T absorbs the light and inhibits the transmission of the laser beam. For example, transmission inhibition liquid LI inhibits the transmission of the light having a wavelength greater than or equal to 0.7 μm and less than or equal to 10 μm.

For example, the transmittance of the light in a wavelength range greater than or equal to 0.7 μm and less than or equal to 10 μm in transmission inhibition liquid LI is less than or equal to 10%/cm. For example, the transmittance of the light in the wavelength range greater than or equal to 0.7 μm and less than or equal to 10 μm in transmission inhibition liquid LI is preferably less than or equal to 5%/cm. For example, the transmittance of the light in the wavelength range greater than or equal to 0.7 μm and less than or equal to 10 μm in transmission inhibition liquid LI is more preferably less than or equal to 3%/cm.

Transmission inhibition liquid LI contains an additive that absorbs or scatters the light in the wavelength range greater than or equal to 0.7 μm and less than or equal to 10 μm in order to inhibit the transmission of the light in the wavelength range greater than or equal to 0.7 μm and less than or equal to 10 μm. For example, this additive contains carbon. The additive is preferably black. For example, transmission inhibition liquid LI is an aqueous solution obtained by adding carbon to water. For example, transmission inhibition liquid LIis an aqueous solution obtained by adding 0.1 vol % of India ink to water. The water in the present specification may be tap water or pure water. The India ink is obtained by dispersing carbon black (carbon) in an aqueous solution of glue or another water-soluble resin, and a mixing ratio of the carbon black is 4.0 wt % to 20.0 wt %, preferably 5.0 wt % to 10.0 wt % with respect to the total amount. For example, the India ink is commercially available “Kuretake concentrated ink Bokuteki BA7-18”.

Transmission inhibition liquid LI preferably contains a rust inhibitor. The rust inhibitor is a corrosion inhibitor that inhibits corrosion of a steel material or the like. For example, the rust inhibitor is water-soluble. For example, a precipitated film type inhibitor, a passive type inhibitor, or a deoxygenated type inhibitor may be used as the rust inhibitor.

Preferably transmission inhibition liquid LI contains a water substituting agent (water draining agent). The water substituting agent improves a water draining property of workpiece WO. The water substituting agent is a solvent that peels liquid such as water from a surface of a substance wetted with the liquid. For example, the water substituting agent may act to repel the liquid such as water by forming a monomolecular thin film on the surface of the substance.

Laser processing device 20 further includes a controller 50 and a processing start switch 52. Processing start switch 52 issues an instruction to start the laser processing by laser processing device 20, for example, in response to an external operation by an operator. Processing start switch 52 may be provided on operation panel 30 (FIG. 1). Processing start switch 52 may be a touch panel provided on operation panel 30.

Processing start switch 52 is connected to controller 50. Controller 50 receives a processing start instruction by processing start switch 52. Controller 50 is connected to liquid level detection sensor 41 of each of containers 1F, 1S, 1T. Controller 50 receives a signal indicating the liquid level of transmission inhibition liquid LI in each of containers 1F, 1S, T detected by liquid level detection sensor 41 of each of containers 1F, 1S, 1T.

Controller 50 controls each unit based on the acquired processing start signal. Controller 50 controls to open and close supply valve 31, pressurizing valve 32, pressure reducing valve 33, and the discharge valve in each of containers 1F, 1S, 1T. Controller 50 controls drive mechanism 25 (FIG. 1) such that laser head 10 moves in the X-, Y-, and Z-directions. Controller 50 controls laser emission from laser head 10.

Controller 50 controls to open and close pressurizing valve 32 or pressure reducing valve 33 based on the detection result of liquid level detection sensor 41. Thus, an amount of gas stored in liquid level adjustment tank 4 is adjusted, and the liquid level of transmission inhibition liquid LI stored in each of containers 1F, 1S, 1T is adjusted. In this manner, controller 50 controls to open and close pressurizing valve 32 or pressure reducing valve 33 and adjusts the liquid level of transmission inhibition liquid LI stored in each of containers IF, IS, 1T.

Under the control of controller 50, liquid level adjustment mechanisms 47 of each of containers 1F, 1S, 1T operates independently. Thus, the liquid level of transmission inhibition liquid LI stored in each of containers 1F, 1S, T can be adjusted individually.

Controller 50 controls laser head 10 and drive mechanism 25 (FIG. 1). Thus, each of workpieces WO1, WO2, WO3 supported by each of containers 1F, 1S, 1T is laser-processed by laser head 10. In addition, controller 50 moves laser head 10 along a preset movement trajectory in each of workpieces WO1, WO2, WO3 during laser processing (when laser head 10 emits the laser beam).

For example, controller 50 is a processor, and may be a central processing unit (CPU).

As illustrated in FIG. 5, side wall 1ba between container 1F and container 1S may have a lower wall LP and an upper wall UP, and upper wall UP may be detachable from lower wall LP. With reference to FIG. 6, a configuration of side wall 1ba will be described below.

As illustrated in FIG. 6, lower wall LP is connected to bottom wall 1a and rises upward in the Z-direction from bottom wall 1a. Both ends in the Y-direction of side wall 1ba are connected to side wall 1bb extending along the X-direction. The height position of the upper end of lower wall LP is lower than the height position of the upper end of side wall 1bb. Each of side wall 1bb and lower wall LP includes pallet support 1c. Side wall 1bb, lower wall LP, and bottom wall 1a are included in the body of liquid tank 1.

Upper wall UP is detachable from lower wall LP. Upper wall UP is disposed on the upper end of lower wall LP. Upper wall UP is a partition wall that separates container 1F and container 1S, and is configured to be detachable from the body (side wall 1bb, lower wall LP, bottom wall 1a) of liquid tank 1.

Each of upper wall UP and the body of liquid tank 1 is configured to engage with each other while upper wall UP is attached to the body. Specifically, the body includes a holding unit SA, and upper wall UP includes a holding unit SB. Each of holding unit SA and holding unit SB is configured by two plate members opposite to each other with a gap.

Holding unit SA of the body is attached to side wall 1bb above lower wall LP. Each of the two plate members configuring holding unit SA of the body protrudes from side wall 1bb toward the inside of liquid tank 1. The end in the Y-direction of upper wall UP can be inserted into the gap between the two plate members configuring holding unit SA of the body.

Holding unit SB of upper wall UP is located at a lower portion of upper wall UP. Each of the two plate members configuring holding unit SB protrudes downward of upper wall UP. The upper end of lower wall LP can be inserted into the gap between the two plate members configuring holding unit SB of upper wall UP.

Both ends in the Y-direction of upper wall UP are inserted into holding unit SA, and the upper end of lower wall LP is inserted into holding unit SB, whereby upper wall UP is engaged with and attached to the body of liquid tank 1.

The engagement between the body of liquid tank 1 and upper wall UP prevents transmission inhibition liquid LI from flowing from one container of container 1F and container 1S into the other container. A sealing member such as packing may be disposed in the engagement unit between the body of liquid tank 1 and upper wall UP. In the laser processing operation, a difference in the liquid level between container 1F and container 1S may be maintained for about several hours. For this reason, the engagement unit between the body of liquid tank 1 and upper wall UP may not be a complete liquid seal.

As illustrated in FIG. 5, for example, the height position of the upper end of lower wall LP is set to the position lower than height position HL of placement unit 2c of cutting pallet 2. The height position of the upper end of upper wall UP attached to the body of liquid tank 1 is set to the position higher than a liquid level 1L of transmission inhibition liquid LI during laser cutting (the position higher than the upper surface of workpiece WO1), which will be described in detail later, and for example, is substantially the same as the height position of the upper end of side wall 1b (1bb) along the X-direction.

Side wall 1b separating container 1S and container IT may have the same configuration as side wall 1ba including lower wall LP and upper wall UP as described above.

### Functional Block of Controller

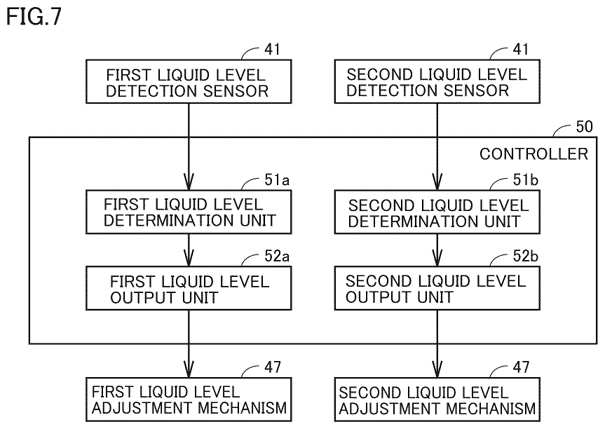

With reference to FIG. 7, a functional block of controller 50 in FIG. 5 will be described below.

FIG. 7 is a functional block diagram illustrating the controller in FIG. 5. As illustrated in FIG. 7, controller 50 includes a first liquid level determination unit 51a, a first liquid level output unit 52a, a second liquid level determination unit 51b, and a second liquid level output unit 52b.

First liquid level determination unit 51a acquires a detection signal of first liquid level detection sensor 41. For example, first liquid level detection sensor 41 is a liquid level detection sensor provided in container 1F. For example, first liquid level determination unit 51a determines the liquid level of transmission inhibition liquid LI in container 1F based on the detection signal of first liquid level detection sensor 41. First liquid level determination unit 51a outputs a signal indicating a determination result to first liquid level output unit 52a.

For example, first liquid level output unit 52a calculates the target liquid level of transmission inhibition liquid LI in container 1F based on the signal indicating the determination result acquired from first liquid level determination unit 51a. First liquid level output unit 52a outputs a control signal controlling first liquid level adjustment mechanism 47 so as to achieve the calculated target liquid level to first liquid level adjustment mechanism 47.

For example, first liquid level adjustment mechanism 47 is liquid level adjustment mechanism 47 provided in container 1F. For example, the liquid level of transmission inhibition liquid LI in container 1F can be adjusted by first liquid level adjustment mechanism 47.

Second liquid level determination unit 51b acquires the detection signal of second liquid level detection sensor 41. For example, second liquid level detection sensor 41 is a liquid level detection sensor provided in container 1S. For example, second liquid level determination unit 51b determines the liquid level of transmission inhibition liquid LI in container 1S based on the detection signal of second liquid level detection sensor 41. Second liquid level determination unit 51b outputs the signal indicating the determination result to second liquid level output unit 52b.

For example, second liquid level output unit 52b calculates the target liquid level of transmission inhibition liquid LI in container 1S based on the signal indicating the determination result acquired from second liquid level determination unit 51b. Second liquid level output unit 52b outputs a control signal controlling second liquid level adjustment mechanism 47 so as to achieve the calculated target liquid level to second liquid level adjustment mechanism 47.

For example, second liquid level adjustment mechanism 47 is liquid level adjustment mechanism 47 provided in container 1S. For example, the liquid level of transmission inhibition liquid LI in container 1S can be adjusted by second liquid level adjustment mechanism 47.

Controller 50 having the above configuration can independently adjust the liquid levels of transmission inhibition liquid LI in the two containers (for example, containers 1F, 1S).

When the liquid level of transmission inhibition liquid LI in each of three containers 1F, 1S, 1T is independently adjusted, controller 50 additionally includes a third liquid level determination unit and a third liquid level output unit. The third liquid level determination unit acquires the detection signal of liquid level detection sensor 41 provided in container 1T. The third liquid level determination unit determines the liquid level of transmission inhibition liquid LI in container 1T based on the detection signal of liquid level detection sensor 41 provided in container 1T. The third liquid level output unit calculates the target liquid level of transmission inhibition liquid LI in container 1T based on the signal indicating the determination result acquired from the third liquid level determination unit. The third liquid level output unit controls liquid level adjustment mechanism 47 provided in container 1T so as to be the calculated target liquid level, thereby adjusting the liquid level of transmission inhibition liquid LI in container 1T.

### Laser Processing Method

With reference to FIGS. 1, 4, and 5, the laser processing method using laser processing device 20 of the embodiment will be described below.

As illustrated in FIG. 1, transmission inhibition liquid LI is supplied into each of containers 1F, 1S, 1T of laser processing device 20. At this point, as illustrated in FIG. 5, controller 50 controls to open supply valve 31 of each of containers 1F, 1S, 1T.

Thus, transmission inhibition liquid LI is individually supplied to each of containers 1F, 1S, 1T from supply pipe 36 of each of containers 1F, 1S, 1T.

At this point, controller 50 detects the liquid level of transmission inhibition liquid LI in each of containers 1F, 1S, 1T by liquid level detection sensor 41 of each of containers 1F, 1S, 1T. When determining that the liquid level of transmission inhibition liquid LI in each of containers 1F, 1S, 1T reaches a desired liquid level SL based on the detection result of liquid level detection sensor 41, controller 50 controls supply valve 31 of each of containers 1F, 1S, 1T to be closed. At this point, for example, transmission inhibition liquid LI is supplied to a position SL lower than height position HL of placement unit 2c of cutting pallet 2.

As illustrated in FIG. 1, then workpieces WO1, WO2, WO3 are carried in containers 1F, 1S, 1T, respectively. For example, each of workpieces WO1, WO2, WO3 is carried in using a crane. The size of the planar shape of each of workpieces WO1, WO2, WO3 is within the range of the size of the planar shape of each of containers 1F, 1S, 1T. In this state, the laser processing operation by laser processing device 20 is started.

As illustrated in FIG. 5, for example, the laser processing operation in laser processing device 20 is started by operating processing start switch 52. When the laser processing operation is started, controller 50 controls laser processing device 20 to sequentially perform the laser processing on each of workpieces WO1, WO2, WO3.

As illustrated in FIG. 1, for example, laser head 10 first performs the laser processing on workpiece WO1 supported by container 1F. When the laser processing of workpiece WO1 is completed, laser head 10 moves to perform the laser processing of workpiece WO2 supported by container 1S. When the laser processing of workpiece WO2 is completed, laser head 10 moves to perform the laser processing of workpiece WO3 supported by container 1T.

When each of workpieces WO1, WO2, WO3 is subjected to the laser processing, the liquid level of transmission inhibition liquid LI in each of containers 1F, 1S, 1T is raised. As illustrated in FIG. 4, the laser processing is performed while the liquid level of transmission inhibition liquid LI is higher than the upper surfaces of workpieces WO1, WO2, WO3. After the laser processing of each of workpieces WO1, WO2, WO3 is completed, the liquid level of transmission inhibition liquid LI in containers 1F, 1S, 1T is lowered.

Upper wall UP is attached to the body of liquid tank 1 between container 1F and container 1S and between container 1S and container 1T. For this reason, the liquid level of transmission inhibition liquid LI in containers 1F, 1S, 1T can be individually adjusted.

After the laser processing of workpiece WO1 on container 1F is completed and the liquid level of transmission inhibition liquid LI in container 1F is lowered, processed workpiece WO1 is carried out of container 1F. The carrying-out of workpiece WO1 on container 1F is performed during a laser processing step in another container. That is, the carrying-out of workpiece WO1 on container 1F is performed at any one of timing of the raising of the liquid level of transmission inhibition liquid LI in container 1S (or container 1T), the laser processing of workpiece WO2 (or workpiece WO3 in container 1T) in container 1S, and the lowering of the liquid level of transmission inhibition liquid LI in container 1S (or container 1T).

After the laser processing of workpiece WO2 on container 1S is completed and the liquid level of transmission inhibition liquid LI in container 1S is lowered, processed workpiece WO2 is carried out of container 1S. The carrying-out of workpiece WO2 on container 1S is performed during a laser processing step in another container. That is, the carrying-out of workpiece WO2 on container 1S is performed at any one of timing of the raising of the liquid level of transmission inhibition liquid LI in container 1T, the laser processing of workpiece WO3 in container 1T is performed, and the lowering of the liquid level of transmission inhibition liquid LI in container 1T.

After the laser processing of workpiece WO3 on container 1T is completed and the liquid level of transmission inhibition liquid LI in container 1T is lowered, processed workpiece WO3 is carried out of container 1T.

In this way, the processes from when each of workpiece WO1, WO2, WO3 is carried in each of containers 1F, 1S, 1T to when processed workpiece WO3 is carried out from container 1T is defined as one turn, and the laser processing operation is completed at the time when the one turn is completed. The laser processing operation may be completed after the one turn is repeated a plurality of times. Thus, the laser processing may be continuously performed in a plurality of containers by repeating carrying of a new workpiece in one container after carrying the workpiece in the one container and during the laser processing in another container.

As described above, when viewed for each container, the laser processing of the embodiment is performed in order of the carrying-in of the workpiece, the raising of the liquid level of transmission inhibition liquid LI, the laser processing of the workpiece, the lowering of the liquid level of transmission inhibition liquid LI, and the carrying-out of the workpiece. The raising of the liquid level of transmission inhibition liquid LI, the laser processing, and the lowering of the liquid level of transmission inhibition liquid LI will be specifically described below.

When each of workpieces WO1, WO2, WO3 is processed, controller 50 raises the liquid level of transmission inhibition liquid LI stored in each of containers 1F, 1S, 1T to target liquid level PL as illustrated in FIG. 5. At this point, controller 50 adjusts the liquid level of transmission inhibition liquid LI based on the detection result of liquid level detection sensor 41 of each of containers 1F, 1S, 1T.

Target liquid level PL of transmission inhibition liquid LI is higher than height position HL of placement unit 2c. In the embodiment, for example, target liquid level PL of transmission inhibition liquid LI is adjusted to position PL higher than the upper surface of each of workpieces WO1, WO2, WO3. Thus, the whole of each of workpieces WO1, WO2, WO3 sinks (is immersed) in transmission inhibition liquid LI during the laser processing.

When the liquid level of transmission inhibition liquid LI is raised to target liquid level PL, controller 50 controls liquid level adjustment mechanism 47. Specifically, for example, controller 50 controls pressurizing valve 32 to open. Thus, the gas is supplied into liquid level adjustment tank 4, and the liquid level of transmission inhibition liquid LI stored in each of containers 1F, 1S, 1T is adjusted to be high to target liquid level PL.

When liquid level detection sensor 41 detects that the liquid level of transmission inhibition liquid LI reaches target liquid level PL, the processing of workpieces WO1, WO2, WO3 is started. During the laser processing of workpiece WO1, WO2, WO3, workpieces WO1, WO2, WO3 are irradiated with the laser beam from laser head 10. Furthermore, the assist gas is blown from laser head 10 toward workpieces WO1, WO2, WO3.

Controller 50 controls drive mechanism 25 during the laser processing of workpieces WO1, WO2, WO3. Thus, for example, laser head 10 moves along the product shape.

As illustrated in FIG. 4, transmission inhibition liquid LI is pushed away at a processing point of workpieces WO1, WO2, WO3 by blowing force of the assist gas. Thus, the upper surfaces of workpieces WO1, WO2, WO3 are exposed from transmission inhibition liquid LI at the processing points of workpieces WO1, WO2, WO3.

The upper surfaces of workpieces WO1, WO2, WO3 exposed from transmission inhibition liquid LI are irradiated with the laser beam. Workpieces WO1, WO2, WO3 are processed by the irradiation with the laser beam. Thus, for example, workpieces WO1, WO2, WO3 are cut. The laser beam that penetrates workpieces WO1, WO2, WO3 by cutting workpieces WO1, WO2, WO3 enter transmission inhibition liquid LI stored below workpieces WO1, WO2, WO3.

During the laser processing, the liquid level of transmission inhibition liquid LI is higher than lower end 7L of light shielding cover 7. For this reason, the assist gas blown out from laser head 10 is blocked by transmission inhibition liquid LI, but does not escape from between lower end 7L of light shielding cover 7 and the upper surface of workpiece WO to the outside of light shielding cover 7. The assist gas blown out from laser head 10 passes from the inside to the outside of light shielding cover 7 through first hole 7ba of first upper plate 7b and second hole 7ca of second upper plate 7c. This prevents an increase in the pressure of the gas inside light shielding cover 7 due to the blowing of the assist gas.

The sludge generated during the cutting of workpieces WO1, WO2, WO3 by the laser processing sinks into transmission inhibition liquid LI and accumulates in sludge tray 3 (FIG. 5). For example, the sludge is iron oxide particles in which molten iron is hardened. As described above, the laser processing is performed while workpieces WO1, WO2, WO3 are immersed in transmission inhibition liquid LI, whereby scattering of the sludge generated during the processing to the surroundings is prevented.

When the laser processing is completed, as illustrated in FIG. 5, controller 50 lowers the liquid level of transmission inhibition liquid LI stored in liquid tank 1 to the position lower than the lower surfaces of workpieces WO1, WO2, WO3 based on the detection result of liquid level detection sensor 41. Thus, the whole of workpieces WO1, WO2, WO3 is exposed from transmission inhibition liquid LI.

When the liquid level of transmission inhibition liquid LI is lowered to the position lower than the lower surfaces of workpieces WO1, WO2, WO3, as illustrated in FIG. 5, controller 50 controls pressure reducing valve 33 to be opened. Thus, the amount of gas stored in liquid level adjustment tank 4 is reduced, and transmission inhibition liquid LI flows into liquid level adjustment tank 4. For this reason, the liquid level of transmission inhibition liquid LI in liquid tank 1 is lowered. At this point, controller 50 detects the liquid level of transmission inhibition liquid LI in liquid tank 1 using liquid level detection sensor 41. When determining that the liquid level of transmission inhibition liquid LI in liquid tank 1 reaches desired liquid level SL, controller 50 controls pressure reducing valve 33 to be closed.

After the series of laser processing operations is completed, cutting pallet 2 and sludge tray 3 are removed from each of containers 1F, 1S, 1T. After that, the sludge in sludge tray 3 is removed.

As described above, the laser processing using laser processing device 20 of the embodiment is performed.

### Advantageous Effect of Embodiment

Effects of the embodiment will be described below in comparison with a comparative example.

In the comparative example in which the liquid tank of the laser processing device includes one container, the laser processing operation is performed in order of carrying the workpiece in one container, laser processing, and carrying out. In this comparative example, the laser processing is interrupted during the work of carrying the workpiece in the container and the work of carrying the workpiece out from the container. For this reason, the efficiency of the laser processing work is not good.

In the comparative example, when a black transmission inhibition liquid is used and when the liquid level of the transmission inhibition liquid is raised to the position higher than the upper surface of the workpiece during the laser processing, the workpiece cannot be carried out unless the liquid level of the transmission inhibition liquid is made lower than the upper surface of the workpiece. This is because a worker who performs the carrying-out work gets wet with the liquid, and the worker cannot check the feet by the black transmission inhibition liquid. As described above, because the workpiece cannot be carried out until the liquid level of the transmission inhibition liquid is lower than the upper surface of the workpiece, the efficiency of the laser processing work is not good in the comparative example.

On the other hand, in the embodiment, as illustrated in FIG. 1, laser processing device 20 includes the plurality of (for example, three) containers 1F, 1S, 1T. The liquid level adjustment mechanism 47 provided in each of the plurality of containers 1F, 1S, 1T is independently controlled and operated. For this reason, the laser processing can be performed by individually adjusting the liquid level of transmission inhibition liquid LI in each of the plurality of containers 1F, 1S, 1T. Accordingly, when workpiece WO (for example, workpieces WO1, WO3) is carried in or out of any one of the plurality of containers (for example, containers 1F, 1T), the laser processing can be performed in another container (for example, container 1S) of the plurality of containers. Thus, the interruption time of the laser processing is shortened, so that the efficiency of the laser processing work can be improved as compared with the comparative example.

When the liquid level of transmission inhibition liquid LI is lowered in any one of the plurality of containers (for example, container 1S), the workpiece can be carried in or out in another container (for example, containers 1F, 1T) in the plurality of containers. Thus, the efficiency of the laser processing work can be further improved as compared with the comparative example.

In the embodiment, as illustrated in FIG. 6, liquid tank 1 has upper wall UP that separates container 1F and container 1S. Upper wall UP is configured to be detachable from the body (includes side wall 1bb, lower wall LP, and bottom wall 1a) of liquid tank 1. Thus, as illustrated in FIG. 5, the liquid level of transmission inhibition liquid LI can be individually adjusted in each of container 1F and container 1S while upper wall UP is attached to the body of liquid tank 1. For example, in container 1F, the liquid level of transmission inhibition liquid LI can be adjusted to a position 1L higher than the upper surface of workpiece WO1, and in container 1S, the liquid level of transmission inhibition liquid LI can be adjusted to a position 2L lower than the upper surface of workpiece WO2. Thus, as described above, for example, workpiece WO1 can be laser-processed in container 1F, and workpiece WO2 can be carried in or out of container 1S.

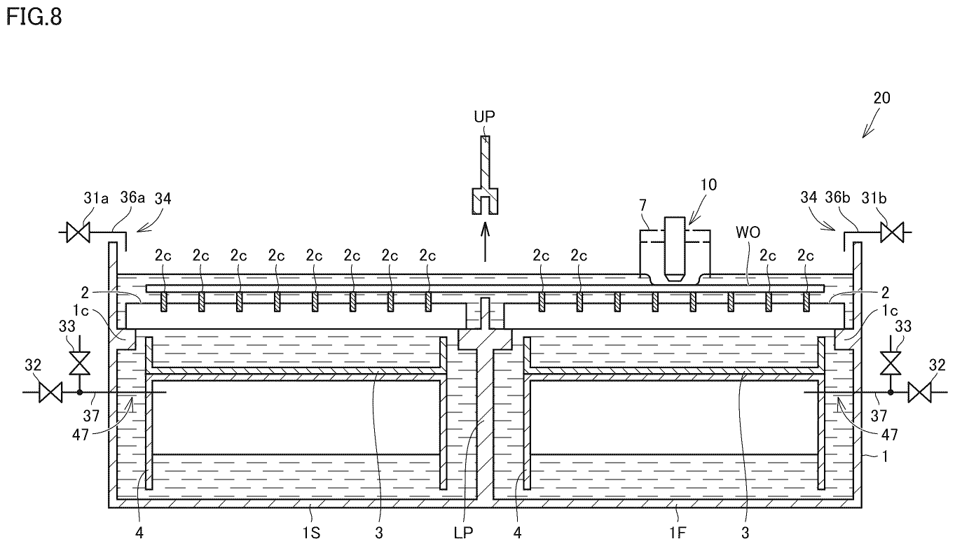

As illustrated in FIG. 8, one workpiece WO can be placed over the plurality of containers (for example, container 1F and container 1S) while upper wall UP is detached from the body of liquid tank 1. For this reason, the laser processing of large-sized (long) workpiece WO cab be coped with.

In the embodiment, as illustrated in FIG. 6, the lower end and both side ends of the upper wall UP is engageable with the body of liquid tank 1. Specifically, the end of upper wall UP in the Y-direction can be inserted into the gap between the two plate members configuring holding unit SA of the body. In addition, the upper end of lower wall LP can be inserted into the gap between the two plate members configuring holding unit SB of upper wall UP. Thus, upper wall UP is firmly supported by the body of liquid tank 1. In addition, leakage of transmission inhibition liquid LI from one of the two containers (for example, containers 1F, 1S) to the other is prevented.

In the embodiment, as illustrated in FIG. 5, the height position of the upper end of upper wall UP is positioned higher than the height positions of the upper surfaces of workpieces WO1, WO2, WO3 supported by containers 1F, 1S, 1T. Thus, the liquid level of transmission inhibition liquid LI in each of containers 1F, 1S, 1T can be individually adjusted even when the liquid level of transmission inhibition liquid LI in each of containers 1F, 1S, 1T becomes higher than the upper surface of workpieces WO1, WO2, WO3 during the laser processing.

In the embodiment, as illustrated in FIG. 5, controller 50 independently controls each of liquid level adjustment mechanism 47 provided in container 1F, liquid level adjustment mechanism 47 provided in container 1S, and liquid level adjustment mechanism 47 provided in container 1T. Thus, the liquid level of transmission inhibition liquid LI stored in each of containers 1F, 1S, 1T can be independently adjusted to perform the laser processing.

In the embodiment, as illustrated in FIG. 5, laser processing device 20 includes liquid level detection sensor 41 that detects the liquid level of container 1F, liquid level detection sensor 41 that detects the liquid level of container 1S, and liquid level detection sensor 41 that detects the liquid level of container 1T. For this reason, the liquid level of each of the plurality of containers 1F, 1S, 1T can be individually detected.

In the embodiment, as illustrated in FIG. 5, a liquid level 2L of transmission inhibition liquid LI in container 1S supporting workpiece WO2 not subjected to the laser processing is lower than upper surface US2 of workpiece WO2 supported by container 1S. In addition, the liquid level of transmission inhibition liquid LI in container 1F supporting workpiece WO1 that is currently subjected to the laser processing is higher than upper surface US1 of workpiece WO1 supported by container 1F. Thus, workpiece WO2 that is not subjected to the laser processing is easily carried out. In workpiece WO1 that is already subjected to the laser processing, the laser beam emitted during the laser processing is absorbed by transmission inhibition liquid LI or the like, so that the leakage of the laser beam to the outside of laser processing device 20 is prevented.

It should be considered that the disclosed embodiments are an example in all respects and not restrictive. The scope of the present invention is defined by not the description above, but the claims, and it is intended that all modifications within the meaning and scope equivalent to the claims are included in the present invention.

### REFERENCE SIGNS LIST

1: liquid tank, 1F, 1S, 1T: container, 1a: bottom wall, 1b, 1ba, 1bb: side wall, 1c: pallet support, 2: cutting pallet, 2a: first support plate, 2b: second support plate, 2c: placement unit, 3: sludge tray, 4: liquid level adjustment tank, 5: head body, 5a: body, 5aa, 5ba: gas outlet, 5ab, 5bb: gas supply unit, 5b: outer nozzle, 6a: condensing lens, 7: light shielding cover, 7L: lower end, 7a: peripheral wall, 7b: first upper plate, 7ba: first hole, 7c: second upper plate, 7ca: second hole, 7d: gap, 7e: internal space, 10: laser head, 20: laser processing device, 21: support base, 22: X-direction movable base, 23: Y-direction movable base, 25: drive mechanism, 30: operation panel, 31: supply valve, 32: pressurizing valve, 33: pressure reducing valve, 34: liquid supply unit, 36: supply pipe, 37: gas pipe, 41: liquid level detection sensor, 47: liquid level adjustment mechanism, 50: controller, 51a: first liquid level determination unit, 51b: second liquid level determination unit, 52: processing start switch, 52a: first liquid level output unit, 52b: second liquid level output unit, LI: transmission inhibition liquid, LP: lower wall, RL: laser beam, SA, SB: holding unit, UP: upper wall, US1, US2: upper surface, WO, WO1, WO2, WO3: workpiece

1. A laser processing device comprising:
a laser head that emits a laser beam;
a liquid tank that includes a first container and a second container separated from each other so as to be capable of individually storing a liquid, the liquid tank being capable of supporting a workpiece to be processed by the laser head in each of the first container and the second container;
a first liquid level adjustment mechanism that adjusts a liquid level of the liquid stored in the first container; and
a second liquid level adjustment mechanism that operates independently of the first liquid level adjustment mechanism and adjusts the liquid level of the liquid stored in the second container.

2. The laser processing device according to claim 1, wherein the liquid tank includes a body and a partition wall that separates the first container and the second container, and
the partition wall is configured to be detachable from the body.

3. The laser processing device according to claim 2, wherein each of a lower end and both side ends of the partition wall is engageable with the body.

4. The laser processing device according to claim 2, wherein a height position of an upper end of the partition wall is higher than a height position of an upper surface of the workpiece supported by each of the first container and the second container.

5. The laser processing device according to claim 1, further comprising a controller that independently controls adjustment of the liquid level of the liquid in the first container by the first liquid level adjustment mechanism and adjustment of the liquid level of the liquid in the second container by the second liquid level adjustment mechanism.

6. The laser processing device according to claim 1, further comprising a first liquid level detection sensor that detects a liquid level of the liquid in the first container; and
a second liquid level detection sensor that detects a liquid level of the liquid in the second container.

7. A laser processing method for processing a workpiece using a laser beam, the laser processing method comprising:
storing a liquid in each of a first container and a second container separated from each other; and
adjusting a liquid level of liquid in the first container and a liquid level of liquid in the second container independently of each other while the workpiece is supported by each of the first container and the second container.

8. The laser processing method according to claim 7, wherein in adjusting the liquid level of the liquid in each of the first container and the second container independently of each other, the liquid level of the liquid in the first container supporting the workpiece that is not subjected to laser processing is lower than an upper surface of the workpiece supported by the first container, and the liquid level of the liquid in the second container supporting the workpiece subjected to the laser processing is higher than an upper surface of the workpiece supported by the second container.
